(19) United States
(12) Patent Application Publication
(10) Pub. No.: US 2005/0087237 A1
(43) Pub. Date: Apr. 28, 2005

(54) Liquid dispensing and recirculating system with sensor

(75) Inventors: Kevin T. O'Dougherty, Arden Hills, MN (US); Cramer C. Hegeman, Excelsior, MN (US)

Correspondence Address: William F. Ryann;ATMI, Inc., 7 Commerce Drive, Danbury, CT, 06810, US

(73) Assignee: Advanced Technology Materials, Inc., Danbury, CT (US)

(21) Appl. No.: 10/694,038

(22) Filed: Oct. 27, 2003

(51) Int. Cl. G05D 7/06

(52) U.S. Cl. 137/590

(57) ABSTRACT

A liquid dispensing and recirculating system is disclosed. The system includes a container having a mouth and a cap coupled with the mouth. The system further includes a connector for coupling with the cap. The connector includes a connector head and a probe extending from the connector head. The probe is insertable through the cap and into the mouth, and has a flow passage therein which terminates near a probe tip. A pump pumps fluid in the container through the probe and the flow passage. A fluid return channel is formed on the probe for returning recirculated fluid to the fluid in the container. As fluid is returned along the fluid return channel, air in the fluid is released above the fluid in the container to prevent injection of air into the fluid in the container.

### BACKGROUND OF THE INVENTION

This invention relates to a storage and dispensing system for the storage and dispensing of liquids. In particular, the invention relates to a coupling member including a probe mounted within a mouth of a container which permits fluid to be drawn out of and recirculated into the container at the same time.

Certain manufacturing processes require the use of liquid chemicals such as acids, solvents, bases, and photoresists. Often, these processes require a specific liquid chemical for each particular process. Furthermore, each process may require a specific liquid chemical at various stages of the process. Storage and dispensing systems allow alternative containers to be used to deliver liquid chemicals to a manufacturing process at a specified time. These process liquids are usually dispensed from pressurized storage and dispensing vessels by special dispensing pumps.

A recirculation loop downstream of the dispensing pump is usually provided to keep the process liquid in continuous fluidic motion at a desired flow rate. Such a recirculation loop reduces solidification of the liquid inside the dispensing lines, prolongs the shelf life of such liquid, and provides a means for purging air out of the dispensing lines.

Typically, the recirculation of the high purity fluids requires a specialized container having at least two ports or mouths in communication with the interior of the container. Because recirculation of the fluids requires a specialized container having two ports, recirculation or testing is expensive. In addition, the structural integrity of the container is often impaired by the need for a second additional mouth or port into the container. Moreover, because recirculation has typically required two ports into the interior of the container, container systems employing flexible bags or film pouches within an outer bottle or overpack are not suitable for recirculating fluids for testing or filtering because the flexible film pouch generally includes only a single port.

Furthermore, the return flow path of conventional recirculation probes terminates right below the neck portion of the container, in order to minimize the inner surface area of the return flow path and to reduce the head losses caused by the flow resistance of the inner surface of the return flow path. However, such design leaves a free space between the end of the return flow path and the liquid surface within the container, and the recirculated liquid therefore drips in a free-fall manner from the return flow path into the container, causing liquid turbulence and formation of air bubbles in the container. Many fluids are rendered defective or unusable by the presence of air bubbles. The present invention is a liquid dispensing and recirculating system which solves these and other problems associated with the prior art systems.

### SUMMARY OF THE INVENTION

The present invention is a liquid dispensing and recirculating system and method. The system includes a container having a mouth and a cap coupled with the mouth. The system further includes a connector for coupling with the cap. The connector includes a connector head and a probe extending from the connector head. The probe is insertable through the cap and into the mouth, and has a flow passage therein which terminates near a probe tip. A pump pumps fluid in the container through the probe and the flow passage. A fluid return channel is formed on the probe for returning recirculated fluid to the fluid in the container. As fluid is returned along the fluid return channel, air in the fluid is released above the fluid in the container to prevent injection of air into the fluid in the container. In a preferred embodiment, the fluid return channel has a first depth at the connector head greater than a second depth at about the tip of the probe, the first depth uniformly transitioning to the second depth along the channel. In another preferred embodiment, the fluid return channel has a uniform depth along its length.

### BRIEF DESCRIPTION OF THE DRAWINGS

FIG. 1 shows a liquid chemical dispensing and recirculating system in accordance with the present invention.

FIG. 2 shows a perspective view of an outer container and a cap.

FIGS. 3 and 4 show perspective views of the outer container, the cap, and a connector.

FIG. 5a shows a perspective view of a probe including a fluid return channel.

FIG. 5b shows a cross-section view of an embodiment of the probe shown in FIG. 5a including a fluid return channel.

FIG. 5c shows a cross-section view of another embodiment of the probe shown in FIG. 5a including a fluid return channel.

FIG. 6 shows a shows a bottom plan view of the connector.

### DETAILED DESCRIPTION

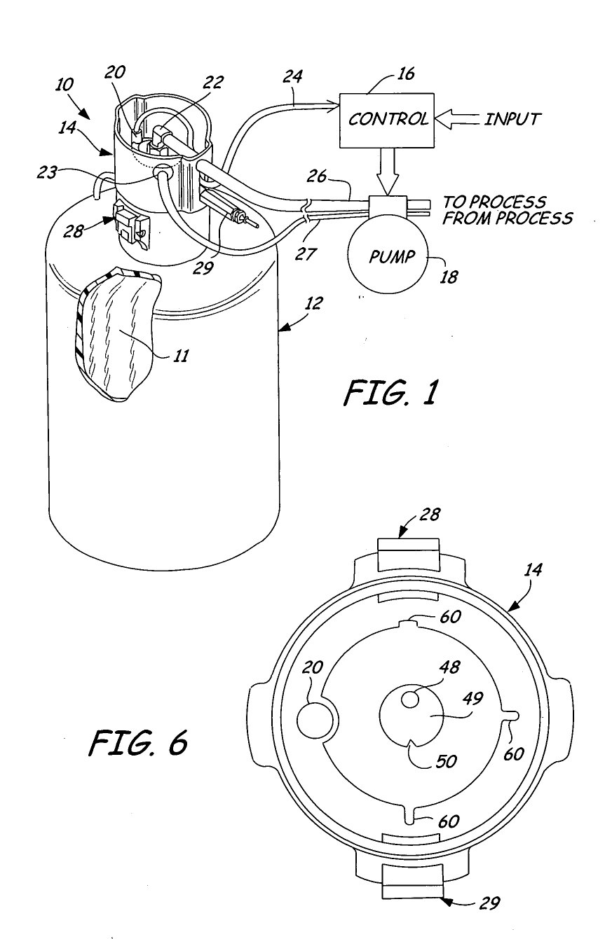

FIG. 1 shows a preferred embodiment of a liquid dispensing and recirculating system 10 in accordance with the present invention. Dispensing and recirculating system 10 includes inner container 11, outer container 12, connector 14, control unit 16, and pump 18. Connector 14 includes sensor 20 and port adaptor 22. Sensor line 24 couples sensor 20 to control unit 16. Adaptor tube 26 connects port adaptor 22 to pump 18.

In operation of dispensing and recirculating system 10, inner container 11 is housed within outer container 12. Inner container 11 is made of a flexible material and outer container 12 is made of a rigid material. Inner container 11 contains a liquid in its interior. For example, inner container 11 may contain a liquid chemical such as photoresist for use in the manufacturing of integrated circuits.

Connector 14 is mounted on outer container 12. Clip 28 aids in securing connector 14 to outer container 12. Additional clips may be used to further secure connector 14 on outer container 12. Adaptor tube 26 and port adaptor 22 provide a fluid passage from the interior of inner container 11 to pump 18. Adaptor tube 27 and port adaptor 23 provide a fluid passage to the interior of inner container 11 from pump 18. When dispensing and recirculating system 10 is properly assembled, pump 18 can pump the liquid in inner container 11 through port adaptor 22 and adaptor tube 26 to a manufacturing process, such as the manufacturing of integrated circuits, and can return liquid to inner container 11 through port adaptor 23 and adaptor tube 27 from a manufacturing process.

Inner container 11 allows for non-contact pressurization of the liquid contained therein. Specifically, inner container 11 is typically a flexible liner (e.g., a bag) located within outer container 12. There is a space between inner container 11 and outer container 12 into which pressurized gas may be introduced. Because inner container 11 is made of a relatively flexible and deformable material, the pressurized gas indirectly applies pressure to the liquid through inner container 11 to aid in dispensing of the liquid without direct contact with the liquid (since the pressurized gas is isolated from the liquid by inner container 11). The pressurized gas may be introduced from an external pressure source into outer container 12 via pressure assist port 29. A pressure relief valve on outer container 12 (not shown) functions to prevent overpressurization within the bottle (or between outer container 12 and inner container 11) when air pressure is being applied to the liner to help in dispensing of the liquid. Pressurized dispensing of the liquid reduces the mechanical load on pump 18 and prolongs the useful life of pump 18, without increasing the risk of contamination of the liquid.

The operation of pump 18 is controlled by control unit 16. Control unit 16 may receive input from an operator relating to starting and stopping pump 18. For example, an operator seeking to start pumping the liquid chemical in inner container 11 to and from a manufacturing process may input this information to control unit 16.

Control unit 16 is also configured to receive signals from sensor 20 via sensor line 24. Sensor 20 senses when a proper connection of connector 14 is made with outer container 12. When proper connection is sensed, sensor 20 sends a first signal indicative of a proper connection to control unit 16 on sensor line 24. When an improper connection is sensed, sensor 20 sends a second signal indicative of a improper connection to control unit 16 on sensor line 24. Control unit 16 will only enable pump 18 when sensor 20 sends a first signal indicative of a proper connection. When control unit 16 receives a second signal indicative of an improper connection from sensor 20, control unit 16 will disable pump 18.

Consequently, when dispensing and recirculating system 10 is not properly assembled and an operator, believing that dispensing and recirculating system 10 is properly assembled, inputs information to start pump 18, pump 18 will not operate. In this way, dispensing and recirculating system 10 prevents the accidental operation of an improperly assembled system.

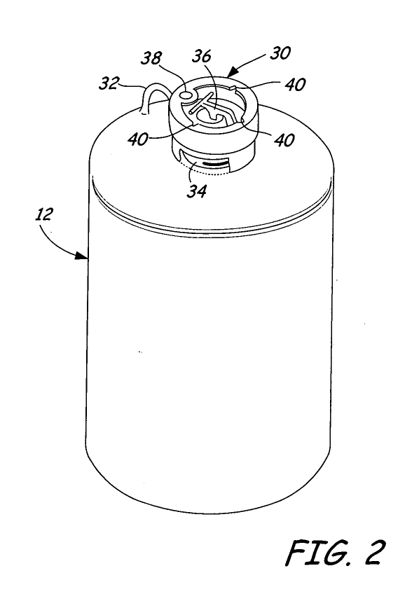

FIGS. 2-4 show a sequence assembling components of dispensing and recirculating system 10. FIG. 2 shows outer container 12 and cap 30. Outer container 12 includes container transport handle 32 and container mouth 34. Cap 30 includes removable cap handle 36, magnet 38 and cap keys 40. Container mouth 34 is externally threaded. Cap 30 is internally threaded to interconnect with mouth 34. Container transport handle 32 aids in the transporting and handling of outer container 12.

Cap 30 is threadably connected to outer container 12 effectively sealing off inner container 11 and its interior in such a way that the liquid contents of inner container 11 cannot escape. Connecting cap 30 with outer container 12 provides an ideal configuration for transportation of high purity fluids without risk of spilling and contamination. Removable cap handle 36 is formed on cap 30 and can be removed to allow access to inner container 11 without removing cap 30. Cap keys 40 are grooves shaped into cap 30. Magnet 38 and cap keys 40 are important to the proper connection of connector 14 to outer container 12, as will be discussed in greater detail below.

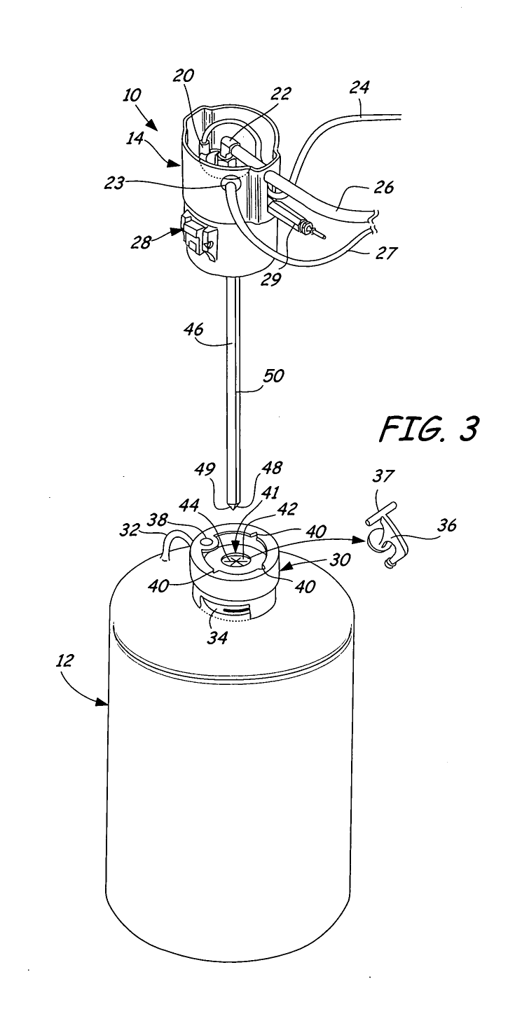

FIG. 3 shows a further sequence of assembling components of dispensing and recirculating system 10. FIG. 3 shows outer container 12, cap 30, and connector 14. Container 12 includes container transport handle 32 and container mouth 34. Cap 30 includes removable cap handle 36 (with handle bar 37), magnet 38, cap keys 40, rupturable membrane 42, and membrane scores 44. Connector 14 includes sensor 20, port adaptor 22, sensor line 24, adaptor tube 26, clip 28, and probe 46. Probe 46 includes lower probe port 48 located adjacent probe tip 49. Probe 46 also includes fluid return channel 50 running longitudinally along an exterior of probe 46.

Cap 30 is threadably connected to mouth 34 of outer container 12. After outer container 12 with cap 30 are transported to the desired location, removable cap handle 36 is removed from cap 30 by lifting on handle bar 37. Cap 30 is pre-scored such that removing handle 36 from cap 30 opens probe hole 41 and vent hole 43. Rupturable membrane 42 is exposed through probe hole 41. Rupturable membrane 42 has membrane scores 44 in its surface.

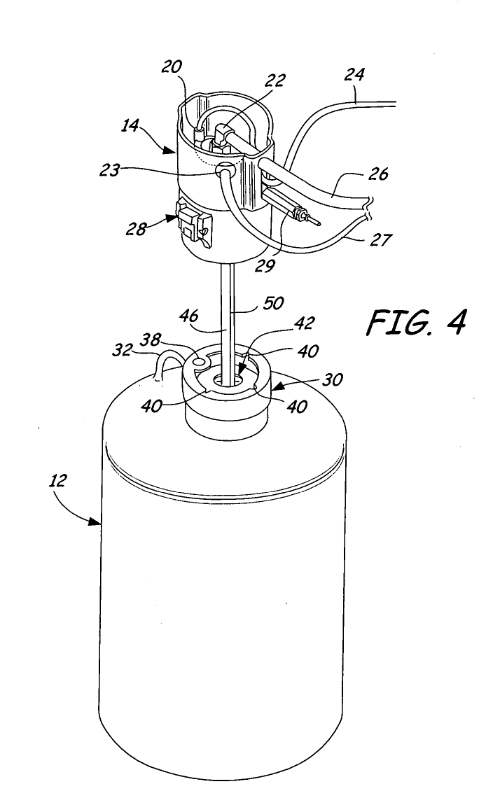

Connector 14 is configured to be interconnected with cap 30. FIGS. 3 and 4 show further sequences of assembling components of dispensing and recirculating system 10. More specifically, connector 14 is shown being interconnected with cap 30 and outer container 12. Probe tip 50 is inserted through probe hole 41 and pressed against rupturable membrane 42 proximate to membrane scores 44. When sufficient pressure is applied on connector 14 toward rupturable membrane 42, probe tip 50 ruptures membrane 42 along membrane scores 44 allowing probe 46 to be inserted through membrane 42. Continued pressure on connector 14 then allows connector 14 to be moved immediately adjacent cap 30. Probe 46 is then in communication with the interior of inner container 11.

FIG. 1 shows connector 14 fully connected with cap 30 and outer container 12. Probe 46, port adaptor 22, and adaptor tube 26 define a fluid passage that allows fluid to be pumped from the interior of inner container 11, through lower probe port 48, through probe 46, through port adaptor 22, and through adaptor tube 26 to pump 18. Adaptor tube 27, port adaptor 23, and fluid return channel 50 define a fluid return passage that allows fluid to be returned to the interior of inner container 11 by passing recirculated fluid through adaptor tube 27, through port adaptor 23 and through fluid return channel 50.

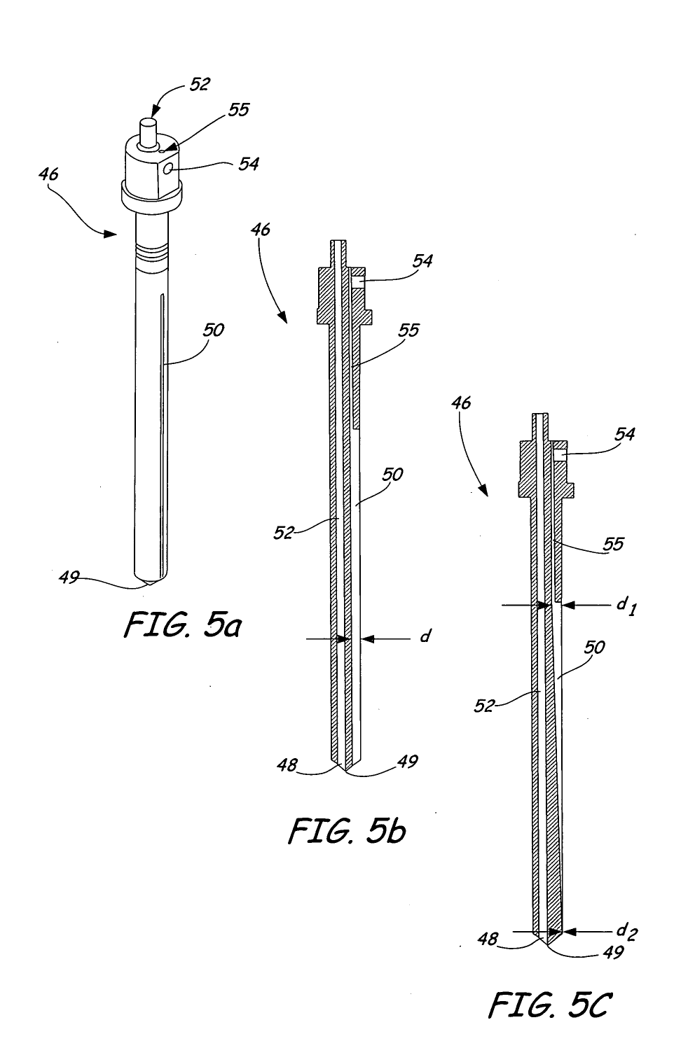

To better illustrate fluid return channel 50 of the present invention, FIG. 5a shows a perspective view of probe 46 separated from connector 14. FIGS. 5b and 5c show cross-section views of two exemplary embodiments of probe 46 including fluid return channel 50. Fluid return channel 50 is preferably formed along an exterior of probe 46 and extends longitudinally along probe 46 generally parallel to fluid passage 52 extending between port adaptor 22 (which adapts to port 54) and lower probe port 48. Fluid return channel 50 is in fluid communication with port adaptor 23 (FIG. 1) via port 54 and bore 55 formed through probe 46. In operation of dispensing and recirculating system 10, recirculated fluid is returned to the interior of inner container 11 via fluid return channel 50. As the return fluid flow reaches fluid return channel 50, fluid trickles down fluid return channel 50 into the fluid contained within inner container 11. The return fluid flow is regulated such that the fluid trickling down fluid return channel 50 flows smoothly into the liquid in inner container 11. This is an improvement over some conventional fluid recirculation systems in which free space at the end of the return flow path allows the recirculated liquid to free-fall from the return flow path into the container, thereby causing turbulence in the fluid.

The return fluid flow also at times has pockets of air interspersed with the fluid as it proceeds from the manufacturing process along adaptor tube 27 toward inner container 11. Some conventional fluid recirculation systems include an enclosed flow path for returning fluid back to the container. These conventional systems trap the pockets of air contained in the return flow path, causing air to be injected into the fluid contained in the vessel as it is returned to the container. Many fluids used in manufacturing processes are rendered defective or unusable by the presence of air bubbles.

In dispensing and recirculating system 10, the pockets of air along the return flow path are released above a surface of the fluid contained in inner container 11 as the return fluid flow reaches fluid return channel 50. This is because fluid return channel 50 is open to the interior of inner container 11, thereby allowing the pockets of air to dissipate immediately upon entering inner container 11. This prevents the injection of air into the fluid within inner container 11.

Fluid return channel 50 is in fluid communication with port adaptor 23 via port 54 and bore 55. Bore 55 preferably has a diameter of less than 0.125 inch, which allows the return fluid flow to remain within fluid return channel 50 such that it trickles into the fluid within inner container 11. Fluid return channel 50 extends from the bore (proximate to the connector head of connector 14) to an area proximate to probe tip 49. In a preferred embodiment, shown in FIG. 5b, fluid return channel 50 has a constant depth, d, from connector 14 to probe tip 49. Depth d is preferably about 0.25 inch. In another preferred embodiment, shown in FIG. 5c, fluid return channel 50 has a first depth, d₁, at the connector head greater than a second depth, d₂, at about probe tip 49, such that the first depth uniformly transitions to the second depth along the length of fluid return channel 49. First depth d₁ is preferably about 0.25 inch and second depth d₂ is preferably a depth <0.25 inch.

FIG. 6 shows a bottom view of connector 14. Connector 14 includes sensor 20, clip 28, clip 29, lower probe port 48, probe tip 49, fluid return channel 50 (depth exaggerated for illustration), and connector keys 60. Connector keys 60 are protrusions carried on connector 14. Connector keys 60 and cap keys 40 are configured for mating such that they must be properly aligned for connector 14 to be properly connected with cap 30. As indicated in FIG. 4, when connector keys. 60 and cap keys 40 are properly aligned for interconnection, sensor 20 will be aligned with magnet 38. Furthermore, when connector 14 is properly connected to cap 30, sensor 20 will also be immediately adjacent magnet 38.

Sensor 20 is configured to send a first signal to control unit 16 on sensor line 24 when sensor 20 is immediately adjacent to, and aligned with, magnet 38. The first signal indicates that connector 14 is properly connected with cap 30. Sensor 20 sends a second signal to control unit 16 on sensor line 24 when sensor 20 is not adjacent magnet 38. The second signal indicates that connector 14 is not properly connected with cap 30.

Control unit 16 monitors sensor line 24 to determine whether connector 14 is properly connected on cap 30. Control unit 16 then controls the operation of pump 18. Control unit 16 accepts input from an operator regarding the operation of pump 18. Control unit 16, however, will not enable the operation of pump 18 unless the first signal is received from sensor 20, indicating that a proper connection between connector 14 and cap 30 is made. Consequently, even if an operator inputs information into control unit 16 attempting to start the operation of pump 18, control unit 16 will not enable pump 18 until the first signal is received from sensor 20. Thus, dispensing and recirculating system 10 will not allow the operation of pump 18 unless there is a proper connection.

Cap 30 is installed on outer container 12 when inner container 11 is initially filled with liquid. Cap 30 has a unique configuration of cap keys 40 that correspond with the particular liquid in inner container 11. Thus, each liquid has its unique cap 30, with a corresponding unique configuration of cap keys 40. For example, inner container 11 filled with liquid photoresist may have a cap 30 with three cap keys 40, two positioned 180 degrees separated with the third approximately half-way between the other two (shown generally in FIG. 2).

Dispensing and recirculating system 10 utilizes one particular liquid chemical for each manufacturing process step requiring a chemical. Thus, each process step is correlated with a connector 14 with a unique configuration of connector keys 60. Each unique configuration of connector keys 60 then corresponds with a unique configuration of cap keys 40, and thus, each connector 14 corresponds with the particular liquid to be used for that step in the process. In this way, only one unique cap 30 and one unique configuration of cap keys 40 will properly interconnect with one unique connector 14 and one unique configuration of connector keys 60. Thus, only one liquid can be used with one step in the manufacturing process.

The present invention is a liquid dispensing and recirculating system and method. The system includes a container having a mouth and a cap coupled with the mouth. The system further includes a connector for coupling with the cap. The connector includes a connector head and a probe extending from the connector head. The probe is insertable through the cap and into the mouth, and has a flow passage therein which terminates near a probe tip. A pump pumps fluid in the container through the probe and the flow passage. A fluid return channel is formed on the probe for returning recirculated fluid to the fluid in the container. As fluid is returned along the fluid return channel, air in the fluid is released above the fluid in the container to prevent injection of air into the fluid in the container. In a preferred embodiment, the fluid return channel has a first depth at the connector head greater than a second depth at about the tip of the probe, the first depth uniformly transitioning to the second depth along the channel. In another preferred embodiment, the fluid return channel has a uniform depth along its length.

As fluid is returned to the container, the returned fluid trickles down the fluid return channel into the fluid contained within the inner container. The return fluid flow is regulated such that the fluid trickling down the fluid return channel flows smoothly into the liquid in inner container. Furthermore, pockets of air along the return flow path are released above a surface of the fluid contained in inner container as the return fluid flow reaches fluid return channel. This is because fluid return channel is open to the interior of the inner container, thereby allowing the pockets of air to dissipate immediately upon entering the inner container. This prevents the injection of air into the fluid within the inner container.

Although the present invention has been described with reference to preferred embodiments, workers skilled in the art will recognize that changes may be made in form and detail without departing from the spirit and scope of the invention. For example, the fluid return channel and recirculation system heretofore described may also be incorporated into the liquid handling system described in U.S. Pat. Pub. No. 2003/0004608 A1 by O'Dougherty et al., entitled “LIQUID HANDLING SYSTEM WITH ELECTRONIC INFORMATION STORAGE,” or the liquid handling system described in U.S. Pat. Pub. No. 2003/0189667 A1 by O'Dougherty et al., entitled “LIQUID HANDLING SYSTEM WITH ELECTRONIC INFORMATION STORAGE.”

1. A liquid dispensing and recirculating system comprising:
a container having a mouth;
a cap for coupling with the mouth;
a connector for coupling with the cap, the connector further comprising:
a connector head; and
a probe extending from the connector head and insertable through the cap and into the mouth, the probe having a flow passage therein which terminates near a probe tip;
pump means coupled with the probe and with the flow passage for pumping fluid in the container through the probe and the flow passage; and
fluid return means formed on the probe for returning recirculated fluid to the fluid in the container such that air in the fluid is released above the fluid in the container to prevent injection of air into the fluid in the container.

2. The liquid dispensing and recirculating system of claim 1, wherein the fluid return means is a fluid channel formed along an exterior of the probe from an area proximate to the connector head to an area proximate to the probe tip.

3. The liquid dispensing and recirculating system of claim 2, wherein the fluid channel has a first depth at the connector head greater than a second depth at about the probe tip, the first depth uniformly transitioning to the second depth along the channel.

4. The liquid dispensing and recirculating system of claim 2, wherein the fluid channel has a uniform depth.

5. The liquid dispensing and recirculating system of claim 2, wherein the fluid channel extends along the probe substantially parallel with the flow passage.

6. The liquid dispensing and recirculating system of claim 1, wherein the fluid return means includes a bore formed at the area proximate to the connector head for delivering the recirculated fluid to the fluid return means.

7. The liquid dispensing and recirculating system of claim 6, wherein the bore is sized such that recirculated fluid remains within the fluid return means as it is returned to the container.

8. The liquid dispensing and recirculating system of claim 1, wherein the cap includes a first key element and the connector includes a second key element configured to mate with the first key element.

9. The liquid dispensing and recirculating system of claim 8, further comprising:
sensor means for sensing when the first and second key elements are mated and for sensing when the first and second key elements are not mated.

10. The liquid dispensing and recirculating system of claim 9, wherein the sensor means comprises a detector mounted on the connector and a detector affecting element mounted on the cap, the detector mounted on the connector having two states, one state when the first and second key codes are mated and the cap and connector are coupled in a predetermined orientation and a second state when the first and second key codes are not mated and the cap and connector are not coupled in the predetermined orientation.

11. The liquid dispensing and recirculating system of claim 9, wherein the sensor means comprises a detector mounted on the cap and a detector affecting element mounted on the connector, the detector mounted on the cap having two states, one state when the first and second key codes are mated and the cap and connector are coupled in a predetermined orientation and a second state when the first and second key codes are not mated and the cap and connector are not coupled in the predetermined orientation.

12. The liquid dispensing and recirculating system of claim 9, further comprising:
controller means coupled with the sensor means and the pump means such that the controller means enables the pump means when the sensor means senses that the first and second key elements are mated and disables the pump means when the sensor means senses that the first and second key elements are not mated.

13. The liquid dispensing and recirculating system of claim 1, further comprising a pressure assist port that is coupled to an external pressure source for introducing pressurized gas into the container to facilitate flow of the fluid from the container.

14. A probe for dispensing liquid from and returning liquid to a container comprising:
a flow passage extending through the probe from a first end of the probe to a second end of the probe;
a fluid return port; and
a fluid return channel in fluid communication with the fluid return port via a bore, the fluid return channel extending longitudinally along an exterior of the probe substantially parallel to the flow passage from the bore to about the second end of the probe.

15. The probe of claim 14, wherein the fluid return channel has a first depth at the bore greater than a second depth at about the second end of the probe, the first depth uniformly transitioning to the second depth along the fluid return channel.

16. The probe of claim 14, wherein the fluid return channel has a uniform depth.

17. A method of dispensing and recirculating liquids comprising:
providing a container having a mouth which communicates with an interior of the container;
attaching a cap over the mouth;
coupling a connector to the cap, wherein the connector includes a probe defining a fluid passage terminating within the interior of the container at a tip of the probe;
defining a fluid return channel on the probe;
dispensing fluid from the container through the fluid passage; and
refilling fluid into the container through the fluid return channel such that air in the fluid is released above the fluid in the container to prevent injection of air into the fluid in the container.

18. The method of claim 17, wherein the steps of dispensing fluid from the container and refilling fluid into the container are performed simultaneously.

19. The method of claim 17, wherein the step of refilling fluid into the container comprises:
recirculating the dispensed liquid back into the container through the fluid return channel.

20. The method of claim 17, wherein the fluid return channel is formed along an exterior of the probe from an area proximate to the connector head to an area proximate to the tip of the probe.

21. The method of claim 20, wherein the fluid return channel has a first depth at the connector head greater than a second depth at about the tip of the probe, the first depth uniformly transitioning to the second depth along the channel.

22. The method of claim 20, wherein the fluid return channel has a uniform depth.

23. The method of claim 20, wherein the fluid return channel is formed along the probe substantially parallel with the flow passage.

24. The method of claim 17, wherein the fluid return channel includes a bore formed at the area proximate to the connector head for delivering the fluid to the fluid channel.
